(19) United States
(12) Patent Application Publication
(10) Pub. No.: US 2026/0105461 A1
(43) Pub. Date: Apr. 16, 2026

(54) FRAMEWORK FOR DETERMINING WARRANTY UPGRADE BASED ON ANALYTIC CALCULATION

(71) Applicant: Dell Products L.P, Round Rock, TX (US)

(72) Inventors: Anay Kishore, Bangalore (IN); Parminder Singh Sethi, Punjab (IN); Praveen Kumar, Noida (IN)

(21) Appl. No.: 18/914,874

(22) Filed: Oct. 14, 2024

(51) Int. Cl. G06Q 30/012

(52) U.S. Cl. CPC G06Q 30/012

(57) ABSTRACT

A method for warranty upgrades includes obtaining, by a warranty optimization system, a request for asset analysis of a computing asset, wherein the computing asset is owned and operated by a client, and in response to obtaining the request: performing an asset analysis on the computing asset to identify a historical classification of the computing asset, wherein the asset analysis is performed using current conditions of the computing asset and hardware information of the computing asset, identifying a failure coefficient and a failure duration value each corresponding to the historical classification, applying a hardware healthiness prediction function on the computing asset using a current lifetime of the computing asset, the failure coefficient, and the failure duration value to obtain an asset health prediction, generating a competitive price index (CPI) based on the asset health prediction, and performing a warranty remediation using the CPI.

### BACKGROUND

In a large-scale data environment where computing devices are subject to degradation, hardware issues, and/or other scenarios in which there is a chance the computing devices are to be replaced, consumers using the computing devices may desire to exercise the option for an active warranty to replace one or more of the computing devices. Understanding the reliability of the hardware by both the consumers and the vendors may be beneficial to understanding when such warranty options are exercised.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2.1 shows a flowchart of a method for generating historical classifications of computing assets in accordance with one or more embodiments of the invention.

FIG. 2.2 shows a flowchart of a method for managing warranty upgrades in accordance with one or more embodiments of the invention.

FIG. 3 shows an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments disclosed herein include methods and systems for identifying a present health index of computing assets, such as hardware devices or hardware components, by analyzing historical telemetry of a set of computing assets and mapping their respective historical trend with the current condition of the device. The health index may be used for determining how a salesperson or vendor of the corresponding computing device is most likely to benefit from having a discussion with an owner of the computing device for extending or upgrading the warranties of the computing devices. Embodiments of the invention include performing methods for generating a competitive pricing index (CPI) that will quantify the reliability of a hardware device in a customer heterogeneous ecosystem. Embodiments include methods to drive the failure co-efficient to proactively predict the duration between two possible failures for each hardware device. Further, embodiments include methods to identify the potential of providing an upgrade and/or initiating a sale-of-extension of warranty for customers of the analyzed hardware devices based on the corresponding CPIs and failure coefficients.

By using available datasets of computing assets obtained from vendors of the computing assets, the statuses, healthiness and predictions of failure are determined. Additionally, research about the sale, service and replacement history of each hardware device may be used for such determinations. Embodiments of the invention may include determining whether to provide certain competitive (e.g., discounted) prices to customers of the computing assets if such assets are in acceptable enough condition and has a higher reliability.

Various embodiments of the invention are described below.

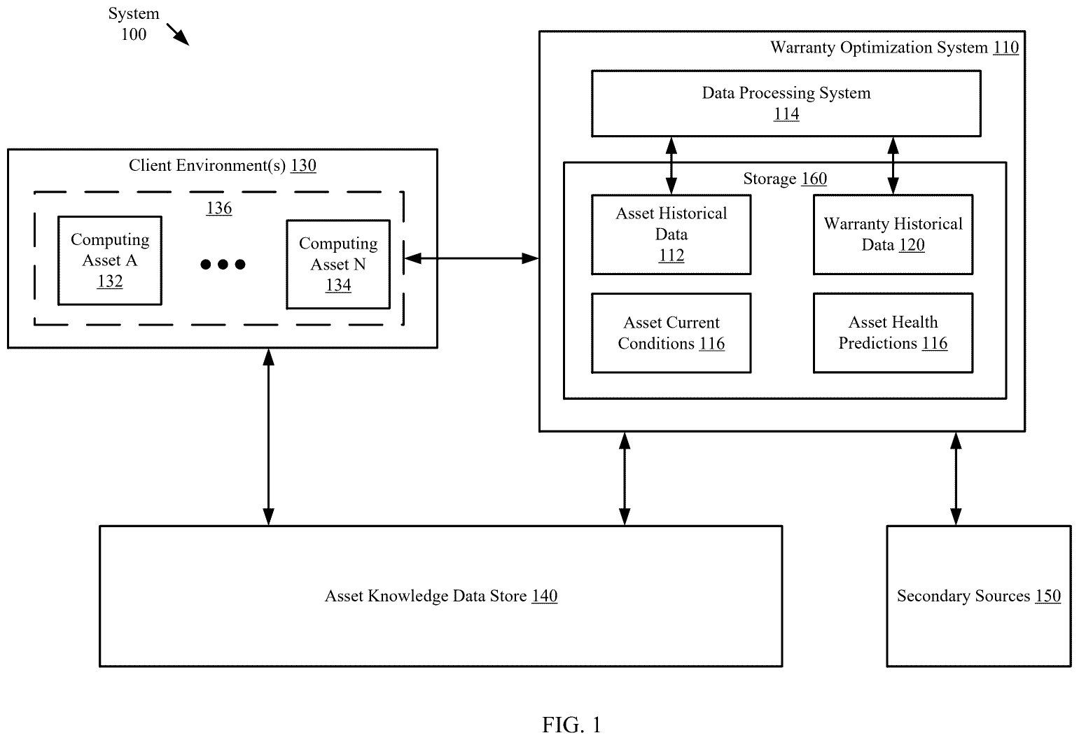

FIG. 1 shows an example system in accordance with one or more embodiments of the invention. The system includes one or more client environments (130) that include any number of computing assets (136), a warranty optimization system (110), an asset knowledge data store (140), and any number of secondary sources (150). The components in the system may be operably connected via any combination of wired and/or wireless connections. The system may include additional, fewer, and/or different components without departing from the invention. Each component in the system is operably connected via any combination of wired and/or wireless connections.

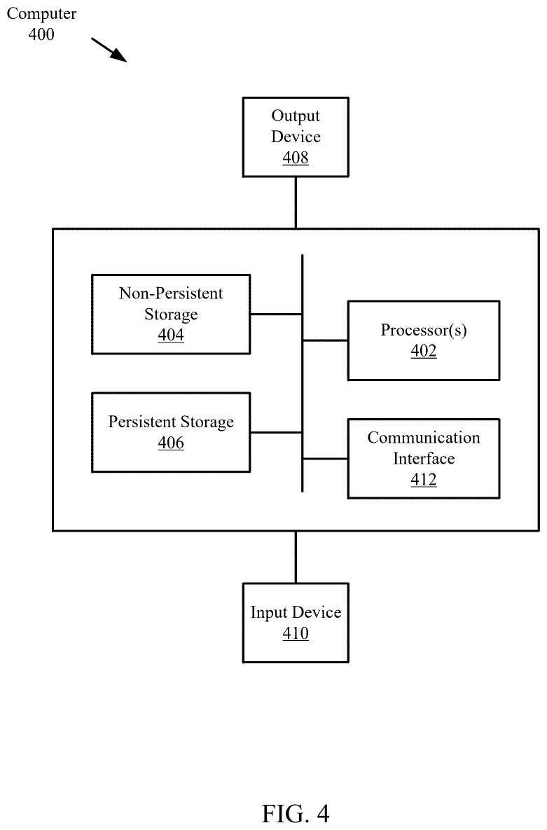

In one or more embodiments disclosed herein, the client environments (130) provide services to users operating the client environments (130). The services may be provided using applications (not shown) executing on the client environments (130). The applications may be logical entities executed using computing resources of the client environments (130). The applications may be hosted on computing assets (132, 134). The computing assets (132, 134) may each be, for example, hardware devices that provide computing resources to users of the client environments (130). Each computing asset (136) may be, for example, a computing device (see e.g., FIG. 4) or a component of a computing device such as a hardware device. Examples of hardware devices include, but are not limited to, central processing units (CPUs), memory boards, random access memory (RAM), graphics processing units (GPUs), server racks, solid state drives (SSDs) (or other persistent storage devices), motherboards, fan modules, power modules, hard drives, slots (e.g., peripheral component interconnect express (PCIe) or universal serial bus (USB)) and networking interface cards (NICs).

In one or more embodiments, the computing assets (136) are purchased by an entity (e.g., a client) that owns the client environments (130) from a vendor of the computing assets (136). During or after purchase, the entity may further purchase warranty protection for one or more of the computing assets (136). The warranty of a computing asset (132, 134) may be a subscription to protection of costs to the client in the event of requiring to replace the computing asset (132, 134) (e.g., as a result of a malfunction or other failure of the computing asset). The warranty protection may be temporary (i.e., it may expire after a predefined period of time). Further, there may be multiple tiers of warranty protection offered by the vendor, each associated with a price based on the level of protection offered by a given warranty. The price of the warranties offered to the computing assets (132, 134) may be determined, for example, by the vendor.

Initial selection of whether to purchase warranty, and the level of protection, may be performed by the client. After expiration of an initial warranty, a client may decide whether to extend or upgrade the initial warranty. Embodiments of the invention include a warranty optimization system (110) that perform analysis on computing assets (e.g., 136) to determine how to calculate optimal price adjustments for a given computing asset based on historical classifications of a set of computing assets (136). To perform such functionality, the warranty optimization system (110) includes a data processing system (114) and storage (160) that includes asset historical data (112), warranty historical data (120), asset current conditions (116), and asset health predictions (116). The warranty optimization system (110) may include additional, fewer, and/or different components without departing from the invention.

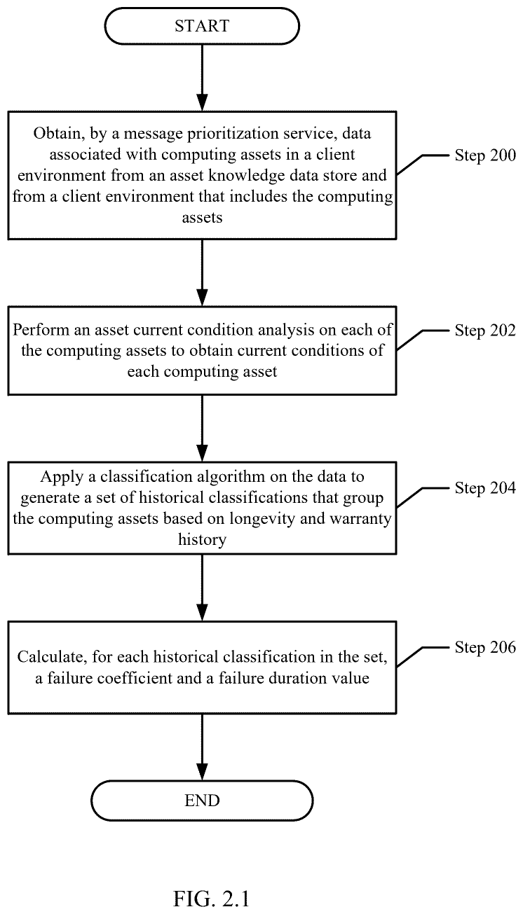

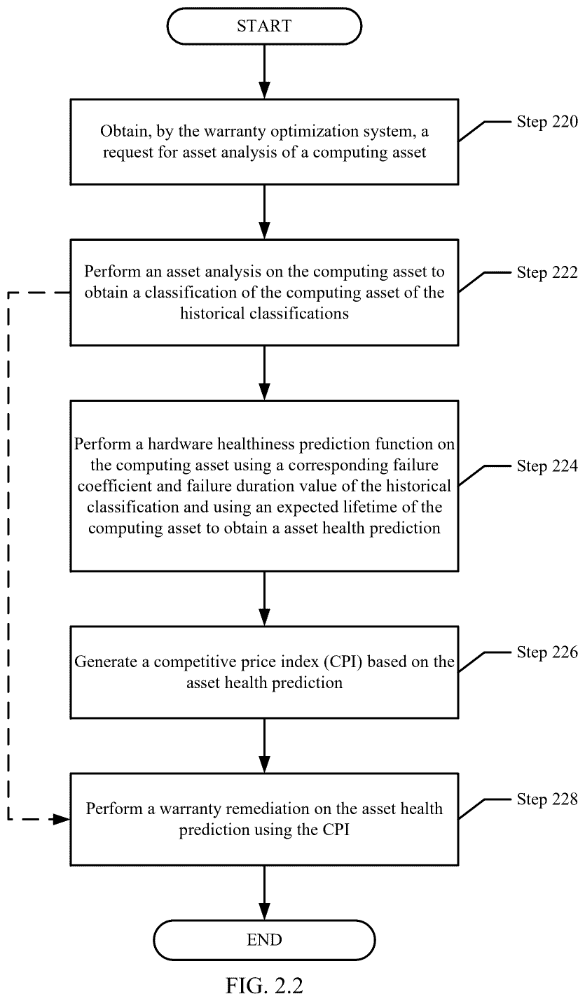

In one or more embodiments of the invention, the data processing system (114) includes functionality for generating historical classifications (see FIGS. 2.1 and 3) used for warranty upgrade decisions in accordance with one or more embodiments of the invention. The historical classifications may be generated using asset historical data (112) and/or asset current conditions (116). Other data may be used for the historical classifications without departing from the invention. The historical classifications may be performed in accordance with FIG. 2.1. Other methods may be used to generate the historical classifications without departing from the invention.

Additionally, the data processing system (114) may include functionality for determining warranty upgrade decisions for a given computing asset (132, 134) using the historical classifications and current conditions of the given computing asset (132, 134). The warranty upgrade decisions may include decisions of whether to recommend extending a warranty for the given computing asset (132, 134), and, if so, determining a competitive price index (CPI) (discussed in FIG. 2.2) to apply to the recommendation for the warranty extension or upgrade. Such determinations may be made by the data processing system (114) by generating asset health predictions (116) and using the asset health predictions (116) to determine warranty upgrade decisions in accordance with, for example, FIG. 2.2. Other methods may be used to determine warranty upgrade decisions without departing from the invention.

In one or more embodiments disclosed herein, the data processing system (114) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data processing system (114) described throughout this application.

In one or more embodiments disclosed herein, the data processing system (114) is implemented as a logical device. The logical device may utilize the computing resources of any number of computing devices and thereby provide the functionality of the data processing system (114) described throughout this application.

In one or more embodiments the asset historical data (112) is a data structure that includes information about hardware components of the computing assets (136) analyzed for the generation of historical classifications. The asset historical data (112) may include hardware information such as, for example, information about prior failures of each computing asset, a type of each computing asset, a sales history of each computing asset, and telemetry of each computing asset that specify any current part issues. Other information that may be included in the asset historical data may include, for example, a performance history of each computing asset, and a date of sale of each computing asset to a client.

In one or more embodiments, at least a portion of the asset historical data (112) is obtained from an asset knowledge data store (140). The asset knowledge data store (140) may be a system of data storage services that stores information about the computing assets (132, 134). The information stored by the asset knowledge data may be generated by a vendor, or manufacturer, of the computing assets (136).

Additionally, at least a portion of the data stored by the warranty optimization system (110) may be obtained from secondary sources (150). The secondary sources (150) may be entities that provide additional information that is stored as asset historical data (112), warranty historical data (120), and/or asset current conditions (116).

For example, a secondary source may include a third-party vendor of a component of a computing asset (132, 134) that replaces a hardware device of proprietary hardware. In this example, any information about the services provided by the secondary source to replace the hardware device with a third-party component may be stored in the asset historical data (112). In contrast, information associated with the manufacturing of the proprietary hardware may be obtained from the asset knowledge data store (140).

In one or more embodiments, the warranty historical data (120) is a data structure that includes information about previous warranties associated with each of the computing assets (136). For example, the warranty historical data (120) may specify a history of warranty sales of each of the computing assets (132, 134), a history of claims (both those accepted and denied) made to exercise a warranty protection of each computing asset (132, 134), and a history of services provided to remediate any claimed issues with each computing assets (132, 134).

In one or more embodiments, the asset current conditions (116) are data structures that specify the current conditions of each of the computing assets (136). The asset current conditions (116) may be calculated based on the asset historical data (112) in accordance with the methods of FIGS. 2.1-2.2. The asset current conditions (116) may specify information such as, for example, a condition of: major hardware devices of each computing asset, slots (e.g., PCIe, USB, serial, etc.) of each computing asset, sensors (temperature, speed, hot swap, etc.) of the computing assets, controllers, and/or any other parts of the computing assets (136).

In one or more embodiments, the data processing system (114) may generate asset health predictions using the information discussed throughout the present disclosure. The asset health predictions (116) may be data structures that indicate a level of health of the computing assets (136) to be used for warranty upgrade decisions. For example, an asset health prediction of a given computing asset (132, 134) may be a numerical value that represents the health of the given computing asset. The asset health prediction may be generated in accordance with, for example, the method of FIG. 2.2.

In one or more embodiments disclosed herein, the warranty optimization system (110) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the warranty optimization system (110) described throughout this application.

In one or more embodiments disclosed herein, the warranty optimization system (110) is implemented as a logical device. The logical device may utilize the computing resources of any number of computing devices and thereby provide the functionality of the warranty optimization system (110) described throughout this application.

While the system of FIG. 1 has been illustrated and described as including a limited number of specific components, a system in accordance with embodiments of the invention may include additional, fewer, and/or different components without departing from the invention.

FIG. 2.1 shows a flowchart for managing message prioritization in accordance with one or more embodiments of the invention. The method shown in FIG. 2.1 may be performed by, for example, a data processing system (114, FIG. 1). Other components of the system illustrated in FIG. 1 may perform the method of FIG. 2.1 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to the method, in step 200, data associated with computing assets in one or more client environments are obtained from an asset knowledge data store and from the one or more client environments. In one or more embodiments, the data includes asset historical data (112, FIG. 1) as described above and warranty historical data (120, FIG. 1) as discussed above.

In step 202, an asset current condition analysis is performed on each of the computing assets to obtain current conditions of each computing asset. In one or more embodiments, the asset current condition analysis includes determining, for each computing asset for which information is obtained, a condition of the components of each computing assets, determining whether any failures are specified in the hardware components, whether any of the current components in the computing asset is a third-party component, and/or a history of use of each computing asset.

In step 204, a classification algorithm is applied on the data and the current conditions of each computing asset to obtain historical classifications that group the computing assets based on longevity and warranty history. In one or more embodiments, the classification algorithm includes using a k-nearest neighbors (KNN) algorithm to group computing assets based on the obtained data and based on the current conditions. The historical classifications may be groupings of computing assets determined based on, for example, any combination of the following: types of warranties applied to the computing assets, a geographic region in which the computing assets operate, a longevity of the computing assets, and other factors without departing from the invention.

In step 206, for each historical classification in the set, a failure coefficient and a failure duration value is calculated. In one or more embodiments, the failure coefficient of a historical classification is a value that corresponds with a mean value of lifetime before computing assets in the historical classifications fail. The failure duration value corresponds to a value used to determine a probability for possible failure between two failures.

FIG. 2.2 shows a flowchart for managing message prioritization in accordance with one or more embodiments of the invention. The method shown in FIG. 2.2 may be performed by, for example, a data processing system (114, FIG. 1). Other components of the system illustrated in FIG. 1 may perform the method of FIG. 2.1 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 220, a request for asset analysis of a computing asset is obtained. The asset analysis may be for a computing asset to be analyzed for determining warranty upgrade decisions. The warranty upgrade decisions may include, for example, determinations to apply a discount to a recommendation to extend a warranty to the computing asset or to recommend an upgrade in warranty type to the computing asset, and if applicable, providing a discount to the upgrade.

In step 222, an asset analysis is performed on the computing asset to obtain a classification of the computing asset of the historical classifications. In one or more embodiments, the asset analysis includes obtaining and identifying relevant data associated with the hardware components of the computing asset to identify a historical classification to which the computing asset is most similar. The asset analysis may include using information such as asset historical data (112, FIG. 1) and warranty historical data (120 FIG. 1) associated with the computing asset to identify the corresponding historical classification.

In one or more embodiments, a set of conditions are analyzed for the computing asset to determine whether to proceed with the method of FIG. 2.2. For example, one condition is whether the computing asset has a history of major failure, mishandling, damage, and/or multiple crashes. If the computing asset does not meet a condition of low failures/crashes, then the computing asset is not further analyzed, a competitive price index (CPI) of the computing asset is set to 0, and the method proceeds to step 228.

In step 224, a hardware healthiness prediction function is performed on the computing asset using a corresponding failure coefficient and failure duration value of the historical classification and using an expected lifetime of the computing asset to obtain an asset health prediction. In one or more embodiments, the hardware healthiness prediction function includes applying a Gamma distribution function on a lifetime of the computing asset and using the corresponding failure coefficient and failure duration value of the corresponding historical classification.

The Gamma distribution function may be represented using the following equation:

$$F ( x ) = \frac{{x}^{a - 1} {e}^{- λ x} {λ}^{a}}{Γ ( a )}$$

In the above equation, λ represents the failure coefficient, a represents the failure duration value, and x represents a variable for a lifetime of the computing asset that may be mapped to F(x), which represents the asset health prediction. Using the above equation, a higher hardware health prediction, the higher the reliability of the computing asset, and the less likely that the computing asset is to fail for a given lifetime, which may be used to calculate the CPI as discussed below.

In one or more embodiments, the given lifetime used to represent x may be based on a potential warranty extension. For example, the given lifetime may be an represented as two years from the current point in time. In this example, the warranty may be expiring soon, and the data processing system may desire to calculate whether the computing asset is likely to be healthy in the next two years.

In step 226, a competitive price index (CPI) is generated based on the asset health prediction. In one or more embodiments, the CPI is generated by calculating a percentage difference between the calculated asset health prediction and a generic health prediction for a generic computing device based on the corresponding historical classification.

For example, consider an asset health prediction for the computing asset as 80% for the next two years, and a generic health prediction for a corresponding historical classification as 70%. In this example, the asset health prediction is 12% higher than the corresponding generic health prediction, giving a CPI of 12%. The CPI is calculated by subtracting the difference of the generic health prediction from the asset health prediction, and dividing the difference by the asset health prediction.

In step 228, a warranty remediation is performed on the asset health prediction using the CPI. In one or more embodiments, the warranty remediation includes calculating a discount to recommend to a client that owns the computing asset. The discount may be calculated using the CPI by providing the percentage represented by the CPI as calculated in step 226.

### Example

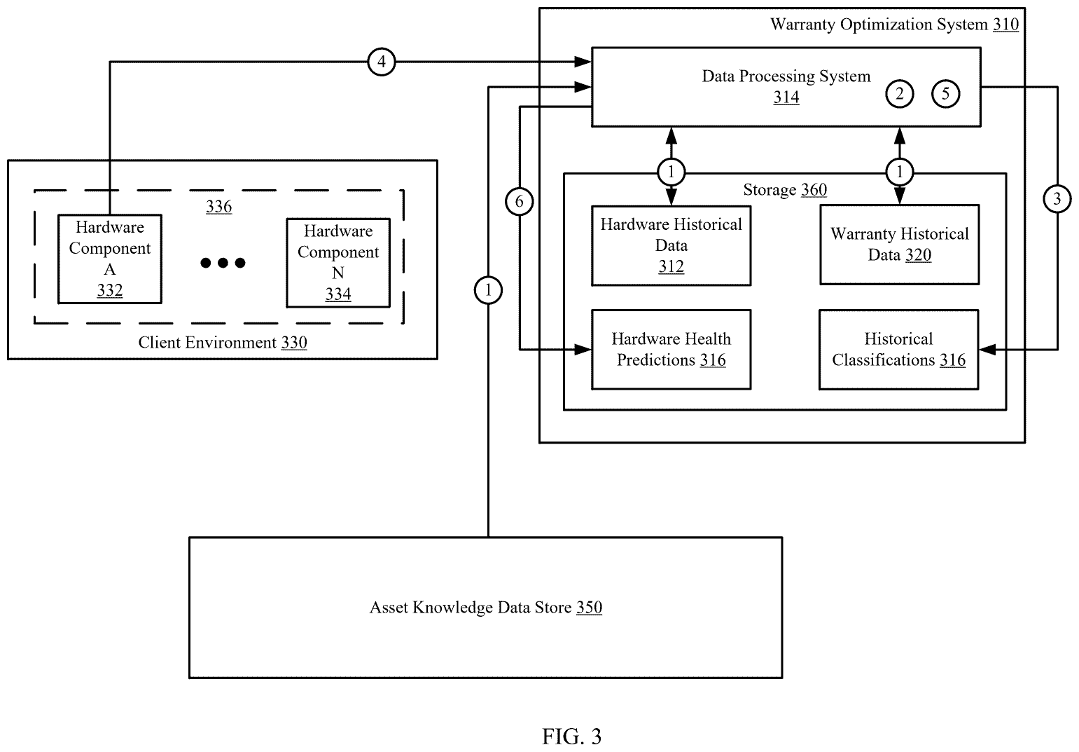

To clarify aspects of the invention, the following describes an example in accordance with one or more embodiments of the invention. The example, described using FIG. 3, is not intended to limit aspects of the invention. In the example, consider a scenario in which hardware components have been purchased by a client and from a vendor. Actions performed by components of FIG. 3 may be represented using circled numbers and described below using brackets (e.g., “[1]”)

Turning to the example, FIG. 3 shows a diagram of an example system in accordance with one or more embodiments of the invention. The example system includes a client environment (330) that includes a set of hardware components (336) that each represents a computing asset. The example system further includes a warranty optimization system (310) and an asset knowledge data store (350) that includes information about the hardware components (336).

At a first point in time, the data processing system (314) receives data from an asset knowledge data store (350) [1]. The data processing system (314) may use the obtained data and hardware historical data and warranty historical data (320) [1]. Specifically, the data processing system (314) performs the method of FIG. 2.1 to process the data obtained from the asset knowledge data store (350), the hardware historical data (312) associated with the hardware components (336), and warranty historical data (320) [2]. The processing includes generating historical classifications (316) using a KNN algorithm [3].

At a later point in time, a request to analyze hardware component A (332) is sent to the data processing system (314) [4]. The request is to determine whether to recommend a warranty extension or upgrade to hardware component A (332). In response to receiving the request, the data processing system (314) performs the method of FIG. 2.2 to service the request by identifying a historical classification, from the generated historical classifications (316), most corresponding to hardware component A (332), identifying a corresponding failure coefficient and failure duration value, and applying a Gamma distribution function on the identified failure coefficient and failure duration value for a given extension of time (e.g., two years) to obtain a hardware health prediction (316) of hardware component A (332). The hardware health prediction (316) describes an 80% probability that hardware component A (332) will be functional in two years and not undergo a failure requiring a warranty claim. Comparing this to a standard 70% probability for generic components in a similar historical classification to hardware component A (332), a 12% increase in probability is calculated. The 12% increase results in a 12% CPI that is used to recommend as a discount on a warranty upgrade and/or extension. A vendor of the warranty sale may utilize the CPI to propose such discount to the client.

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention provide relative measurements and monitoring of the health and degradation of a computing asset such as a hardware device by using known information by a vendor of the assets as well as current conditions based on information obtained from customer use to determine a health index for the given computing asset. The awareness of asset health may improve the use of the computing asset in a client environment.

Embodiments of the invention may further use the asset health to provide competitive pricing on warranty upgrades for the computing assets. By generating a competitive price index for a computing asset, embodiments of the invention provide the ability to determine optimal recommendations for upgrading or extending the warranty of a computing asset based on its sales history, historical classification, warranty claims history, and/or any other information without departing from the invention.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A method for managing warranty upgrades, the method comprising:
obtaining, by a warranty optimization system, a request for asset analysis of a computing asset, wherein the computing asset is owned and operated by a client;
in response to obtaining the request:
performing an asset analysis on the computing asset to identify a historical classification of the computing asset, wherein the asset analysis is performed using current conditions of the computing asset and hardware information of the computing asset;
identifying a failure coefficient and a failure duration value each corresponding to the historical classification;
making a determination that the asset meets a condition of having a history of no major failures, damage, or crashes;
based on the determination, applying a hardware healthiness prediction function on the computing asset using a current lifetime of the computing asset, the failure coefficient, and the failure duration value to obtain an asset health prediction;
generating a competitive price index (CPI) based on the asset health prediction; and
performing a warranty remediation using the CPI,
wherein the warranty remediation comprises performing a warranty upgrade or extension on the computing asset, and
wherein the warranty upgrade or extension is performed by the client for the operation of a computing environment comprising the computing asset.

2. The method of claim 1, wherein the historical classification is generated by:
obtaining data associated with a set of computing assets from an asset knowledge data store;
performing an asset current condition analysis on each of the set of computing assets to obtain current conditions of the set of computing assets; and
applying a classification algorithm on the set of computing assets using the data and based on the current conditions of the set of computing assets to obtain a set of historical classifications, wherein the set of historical classifications comprises at least the historical classification.

3. The method of claim 2, wherein the classification algorithm is a k-nearest neighbor (KNN) machine learning algorithm.

4. The method of claim 2, wherein the set of historical classifications are further based on warranty information of the set of computing assets.

5. The method of claim 1, wherein the hardware healthiness prediction function is a gamma distribution function.

6. The method of claim 1, wherein the hardware information comprises: information about prior failures of the computing asset, a type of the computing asset, and a sales history of the computing asset.

7. The method of claim 1, wherein the warranty remediation comprises applying the CPI to a warranty extension for extending a warranty to the computing asset.

8. The method of claim 1, wherein the computing asset is a hardware component of a computing device.

9. The method of claim 1, wherein the computing asset is a computing device.

10. A non-transitory computer readable medium comprising computer readable program code, which when executed by a computer processor enables the computer processor to perform a method for managing warranty upgrades, the method comprising:
obtaining, by a warranty optimization system, a request for asset analysis of a computing asset, wherein the computing asset is owned and operated by a client;
in response to obtaining the request:
performing an asset analysis on the computing asset to identify a historical classification of the computing asset, wherein the asset analysis is performed using current conditions of the computing asset and hardware information of the computing asset, and wherein the hardware information comprises: information about prior failures of the computing asset, a type of the computing asset, and a sales history of the computing asset;
identifying a failure coefficient and a failure duration value each corresponding to the historical classification;
making a determination that the asset meets a condition of having a history of no major failures, damage, or crashes;
based on the determination, applying a hardware healthiness prediction function on the computing asset using a current lifetime of the computing asset, the failure coefficient, and the failure duration value to obtain an asset health prediction, wherein the hardware healthiness prediction function is a gamma distribution function;
generating a competitive price index (CPI) based on the asset health prediction; and
performing a warranty remediation using the CPI
wherein the warranty remediation comprises performing a warranty upgrade or extension on the computing asset, and
wherein the warranty upgrade or extension is performed by the client for the operation of a computing environment comprising the computing asset.

11. The non-transitory computer readable medium of claim 10, wherein the historical classification is generated by:
obtaining data associated with a set of computing assets from an asset knowledge data store;
performing an asset current condition analysis on each of the set of computing assets to obtain current conditions of the set of computing assets; and
applying a classification algorithm on the set of computing assets using the data and based on the current conditions of the set of computing assets to obtain a set of historical classifications, wherein the classification algorithm is a k-nearest neighbor (KNN) machine learning algorithm, and wherein the set of historical classifications comprises at least the historical classification.

12. The non-transitory computer readable medium of claim 11, wherein the set of historical classifications are further based on warranty information of the set of computing assets.

13. The non-transitory computer readable medium of claim 10, wherein the warranty remediation comprises applying the CPI to a warranty extension for extending a warranty to the computing asset.

14. The non-transitory computer readable medium of claim 10, wherein the computing asset is a hardware component of a computing device.

15. The non-transitory computer readable medium of claim 10, wherein the computing asset is a computing device.

16. A system, comprising:
a processor, and
memory comprising instructions, which when executed by the processor, cause the processor to perform a method, the method comprising:
obtaining, by a warranty optimization system, a request for asset analysis of a computing asset, wherein the computing asset is owned and operated by a client;
in response to obtaining the request:
performing an asset analysis on the computing asset to identify a historical classification of the computing asset, wherein the asset analysis is performed using current conditions of the computing asset and hardware information of the computing asset, and wherein the hardware information comprises:
information about prior failures of the computing asset, a type of the computing asset, and a sales history of the computing asset;
identifying a failure coefficient and a failure duration value each corresponding to the historical classification;
making a determination that the asset meets a condition of having a history of no major failures, damage, or crashes;
based on the determination, applying a hardware healthiness prediction function on the computing asset using a current lifetime of the computing asset, the failure coefficient, and the failure duration value to obtain an asset health prediction, wherein the hardware healthiness prediction function is a gamma distribution function;
generating a competitive price index (CPI) based on the asset health prediction; and
performing a warranty remediation using the CPI,
wherein the warranty remediation comprises performing a warranty upgrade or extension on the computing asset, and
wherein the warranty upgrade or extension is performed by the client for the operation of a computing environment comprising the computing asset.

17. The system of claim 16, wherein the historical classification is generated by:
obtaining data associated with a set of computing assets from an asset knowledge data store;
performing an asset current condition analysis on each of the set of computing assets to obtain current conditions of the set of computing assets; and
applying a classification algorithm on the set of computing assets using the data and based on the current conditions of the set of computing assets and warranty information to obtain a set of historical classifications, wherein the classification algorithm is a k-nearest neighbor (KNN) machine learning algorithm, and wherein the set of historical classifications comprises at least the historical classification.

18. The system of claim 17, wherein the warranty remediation comprises applying the CPI to a warranty extension for extending a warranty to the computing asset.

19. The system of claim 17, wherein the computing asset is a hardware component of a computing device.

20. The system of claim 17, wherein the computing asset is a computing device.
